(19) United States
(12) Patent Application Publication
(10) Pub. No.: US 2007/0018501 A1
(43) Pub. Date: Jan. 25, 2007

(54) Method and device for electric supply of electric setting mechanisms for motor vehicles

(76) Inventors: Wolfgang Schon, Langenargen (DE); Karl-Hermann Ketteler, Markdorf (DE); Andreas Fuessl, Kressbronn (DE); Jurgen Kett, Friedrichshafen (DE); Allan Muschel, Friedrichshafen (DE)

Correspondence Address: DAVIS & BUJOLD, P.L.L.C., 112 PLEASANT STREET, CONCORD, NH, 03301, US

(21) Appl. No.: 11/487,043

(22) Filed: Jul. 14, 2006

(30) Foreign Application Priority Data
Jul. 21, 2005 (DE) 10 2005 034 036.9

(51) Int. Cl. B60L 1/00

(52) U.S. Cl. 307/10.1

(57) ABSTRACT

A method for an electrical supply of electric setting mechanisms of motor vehicles, particularly of electromagnetic energy converters, with prevailing generator operating modes. One electromagnetic energy converter is coordinated with one accumulator element electrically connected with the power supply or with the power supply battery, the supply voltage of the one electric setting mechanism or of the one electromagnetic energy converter (2) is increased in comparison with the power supply voltage.

This application claims priority from German Application Serial No. 10 2005 034 036.9 filed Jul. 21, 2005.

### FIELD OF THE INVENTION

The invention relates to a method for electric supply of electric setting mechanisms of motor vehicles. The invention further relates to a device for electric supply of electric setting mechanisms of motor vehicles.

### BACKGROUND OF THE INVENTION

Known from the prior art is to install electric setting mechanisms in motor vehicles. This often refers to consumers with high power so that electromagnetic energy converters and voltage stabilizers are used to prevent voltage collapses.

In the field of vehicles, electromagnetic energy converters can be used both for static adjustment problems and for the dynamic control of the vehicle behavior, for example, in the running gear area. Especially for the purpose of dynamic control of the vehicle behavior, the momentary power needed for the setting mechanism is often high and cannot be assisted by the normal power supply of the vehicle. For this reasons, it is required to use electric accumulator elements directly coordinated with the electric mechanisms in order to relieve the power supply of the vehicle. Due to the energy and power density needed for this, it is known to use double-layer capacitors as accumulator elements.

DE 103 45 310 A1 has disclosed an energy power supply with improved loading strategy of the support battery, which has one first energy accumulator, one second energy accumulator, a multiplicity of consumers attached to the power supply and a controllable load and separation unit. By way of the controllable load and separation unit, the second energy accumulator is attached to the power supply. For this purpose, it has shifting mechanisms comprising semiconductor switches by way of a second energy accumulator which can be connected with the power supply. An electric energy management brings the shifting mechanisms to the closed state for reloading the second energy accumulator.

From DE 102 33 816 A1 a method is known for protection of a power supply of a motor vehicle which has one generator and shiftable consumers and within whose scope one main accumulator capacitor, inserted parallel with the generator and whose voltage in loaded state, is at least approximately at the power supply voltage and one additional accumulator capacitor whose voltage in loaded state is substantially lower than that of the main accumulator capacitor, upon a reduction of the actual power supply voltage, are serially connected until the voltage deficit caused by switching in a consumer is compensated by an increase of the generator output voltage.

In the power supply for motor vehicles known from the prior art, the high power of the setting mechanism is supplied with the comparatively low power supply voltage (between 12 V and 24 V), whereby high currents generate which, on one hand, result in larger dimensions of the parts for the electric supply (line cross-sections, contacts, plus, etc.) and/or, on the other, in undesired voltage drops which can impair the operation of the setting mechanism. In addition, the electric accumulator capacity of a used accumulator element is disadvantageously utilized only partly when the voltage level of the accumulator element and the voltage level of the power supply are similar.

This invention is based on the problem of outlining a method for electric supply of electric setting mechanisms of motor vehicles; the application of which overcomes the disadvantages described of the method known from the prior art. Also is a device for electric supply of electric setting mechanisms of motor vehicles is outlined.

### SUMMARY OF THE INVENTION

Accordingly, proposed is a method for an electric supply of electric setting mechanisms of motor vehicles, especially of electromagnetic energy converters with a prevailing generator operating mode, within the scope of which the supply voltage of one electric setting mechanism or of one electromagnetic energy converter is increased in comparison with the power supply voltage.

The inventive idea eliminates the need of larger dimensions of the electric connection technology, since the smaller electric currents, due to the higher voltage, advantageously result in smaller cable cross-sections required and contacts of smaller dimensions. In addition, a power decoupling of the power supply to lower voltage level is possible.

Dynamic electromagnetic energy converters in vehicles, such as electric motors used as setting mechanisms, have to be operated in all four quadrants of the F-v diagram. When using actuators prevailing operation in the generator mode, according to the invention, it is possible to use the generator energy for charging the accumulator elements used, beyond the power supply voltage whereby the described advantages can be achieved.

According to the invention, the accumulator element coordinated directly with the respective electric setting mechanism or electromagnetic energy converter is first charged by a diode connected with the power supply battery to the power supply voltage whereby the electromagnetic energy converter such as the electric motor is capable of starting. The characteristic of many electromagnetic energy converters allow, already with low voltage, to build up the rated force or the rated torque at low motion speed or rotational speed. In this manner, it is possible to implement a basic operation of the electromagnetic energy converter already in the starting phase.

In the operation, the prevailing generator mode loading or the generator mode operation of the electromagnetic energy converter leads to overloading of the accumulator element, since the diode inserted between the accumulator element and the power supply prevents the discharge of the load in the power supply. Since the electric accumulator element usually has only one small self-discharge, the excess voltage once reached remains for a long time at a standstill.

Depending on the system specification, the adjusted voltage of the electromagnetic energy converter can be freely selected and can be higher than the power supply voltage, the full operation being given at the power supply voltage; the adjusted voltage can also be the same as the power supply voltage.

According to the invention, the accumulator rated voltage can also be freely selected and be higher than the adjusted voltage of the electromagnetic energy converter. It can also assume the same value as the adjusted voltage. The higher the accumulator rated voltage compared to the adjusted voltage of the electromagnetic energy converter, the longer can the energy converter or the setting mechanism represent the whole operation with adjusted voltage.

Within the scope of a specially advantageous embodiment of the invention, an excess voltage limiter is provided in the diode, which takes care that when reaching the accumulator voltage the excess load can discharge in the power supply. The diode is preferably designed as a breakdown diode whereby the excess voltage limit desired can be implemented. It is also possible to use other solutions known from the prior art.

The inventive device for electric supply of electric setting mechanisms of motor vehicles, accordingly, comprises one diode inserted between the power supply battery and the accumulator element directly coordinated with the electric setting mechanism or the electromagnetic energy converter and preferably having one excess voltage limiter and, in addition, has the advantage that the parts diode and excess voltage limiter have components which often exist already as inverse polarity protection.

### BRIEF DESCRIPTION OF THE DRAWINGS

The invention will now be described, by way of example, with reference to the accompanying drawings in which:

FIG. 1 shows a diagrammatic shift pattern of the inventive device for electric supply of electric setting mechanisms of motor vehicles.

### DETAILED DESCRIPTION OF THE INVENTION

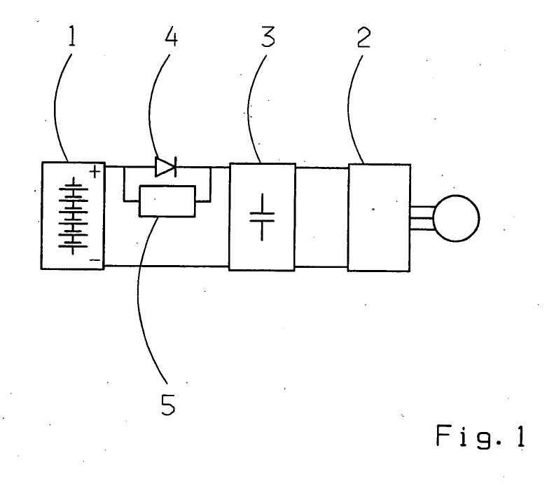

In FIG. 1 the power supply battery 1 and an electromagnetic energy converter or an electric setting mechanism 2 is shown. In addition, directly coordinated with the electric setting mechanism or the electromagnetic energy converter 2, one accumulator element 3 is provided which is preferably designed as a double-layer capacitor and is connected, on one side, with the electric setting mechanism or the electromagnetic energy converter 2 and, on the other side, is electrically connected, via one diode 4, with the power supply of the power supply battery 1. The diode 4 has one excess voltage limiter 5 and, as already explained, is preferably designed as a breakdown diode.

According to the invention, the supply voltage of the electric setting mechanism or of the electromagnetic energy converter 2 is increased compared to the power supply voltage. This results from the fact that in operation the prevailing load or the generator operation of the electromagnetic energy converter 2 leads to overloading the accumulator element 3, since the diode 4, inserted between the accumulator element 3 and the power supply or power supply battery 1, prevents the drain of the charge in the power supply.

Depending on the system specifications, it is possible to freely select the adjusted voltage of the electromagnetic energy converter 2 in a range above the power supply voltage. Besides, the accumulator rated voltage can also be selected higher than the adjusted voltage of the electromagnetic energy converter 2.

The method introduced here can be implemented with conventional components so that the expenses therefor can be kept low. Additionally, a significant cost saving is achieved, since the parts for the electric supply (line cross-sections, contacts, plugs, etc) have smaller dimensions.

Reference Numerals

1 power supply battery
2 electromagnetic energy converter, electric setting mechanism
3 accumulator element
4 diode
5 excess voltage limiter

1-8. (canceled)

9. A method for supplying electricity to at least one electromagnetic energy converter (2) of a motor vehicle, the method comprising the steps of:
coordinating an accumulator element (3), electrically connected with one of a power supply and a battery (1), with the electromagnetic energy converter (2); and
increasing a supply voltage of the at least one electromagnetic energy converter (2) when compared with a voltage of one of the power supply and the battery (1).

10. The method for supplying electricity to the at least one electromagnetic energy converter (2) of the motor vehicle according to claim 9, further comprising the step of using a generator energy of the electromagnetic energy converter (2) to boost the accumulator element (3) beyond the power supply voltage coordinated with the electromagnetic energy converter (2).

11. The method for supplying electricity to the at least one electromagnetic energy converter (2) of the motor vehicle according to claim 9, further comprising the steps of;
boosting the accumulator element (3) directly coordinated with the electromagnetic energy converter (2) to the power supply voltage by one diode (4) connected with one of the power supply and a battery (1), and the diode (4) is inserted between the accumulator element (3) and one of the power supply and a battery (1); and
obtaining by a generator mode operation of the electromagnetic energy converter (2), an overload of the accumulator element (3), since outflow of charge in the power supply is prevented by the diode (4) inserted between the accumulator element (3) and one of the power supply and a battery (1).

12. The method for supplying electricity to the at least one electromagnetic energy converter (2) of the motor vehicle according to claim 9, further comprising the step of freely selecting an adjusted voltage of the electromagnetic energy converter (2) in one of:
a range above the power supply voltage, and
equal to the power supply voltage.

13. The method for supplying electricity to the at least one electromagnetic energy converter (2) of the motor vehicle according to claim 9, further comprising the step of selecting an accumulator rated voltage at one of:
higher than the adjusted voltage of the electromagnetic energy converter (2), and
at a same value.

14. A device for supplying electricity to an electromagnetic energy converter (2), with a prevailing operating mode, the device comprising:
an accumulator element (3) coordinated with the electromagnetic energy converter (2) and connected with a power supply (1); and
a diode (4), inserted between the power supply (1) and the accumulator element (3) coordinated with the one electromagnetic energy converter (2) to prevents a discharge of the accumulator element (3) in the power supply.

15. The device for supplying electricity to the electromagnetic energy converter (2) according to claim 14, wherein the diode (4) has an excess voltage limiter (5) such that when an accumulator rated voltage is reached, any excess charge is discharged in the power supply.

16. The device for supplying electricity to an electromagnetic energy converter (2) according to claim 14, wherein the diode (4) is a breakdown diode.
